(19) United States
(12) Patent Application Publication
(10) Pub. No.: US 2022/0250170 A1
(43) Pub. Date: Aug. 11, 2022

(54) DRILLING AID

(71) Applicant: WOLFCRAFT GMBH, Kempenich (DE)

(72) Inventor: Frank HILGER, Weibern (DE)

(21) Appl. No.: 17/623,736

(22) PCT Filed: Jul. 8, 2020
(86) PCT No.: PCT/EP2020/069169

§ 371 Date: Dec. 29, 2021

(30) Foreign Application Priority Data
Jul. 19, 2019 (DE) 10 2019 119 611.6

(51) Int. Cl. B23B 41/06; B23B 51/04

(52) U.S. Cl. CPC B23B 41/06; B23B 51/0426

(57) ABSTRACT

A device for enlarging a hole with a frustoconical base body that can be inserted into a hole of a workpiece, and has an insertion opening for inserting a pilot drill of a hole saw. The frustoconical shell surface of the base body has a self-tapping thread, which can engage into the wall of the hole to be enlarged. A screwdriver is provided to apply the correspondingly large torque.

The invention relates to a device for enlarging a hole with a frustoconical base body that can be inserted into a hole of a workpiece, and has an insertion opening for inserting a pilot drill of a hole saw.

### PRIOR ART

A device of the generic type is known from U.S. Pat. No. 5,871,310 A. Described therein is a device that has a frustoconical base body. The frustoconical shell surface of the frustoconical base body has a ribbed structure, wherein the ribs run in an axial/radial direction. An insertion opening is provided, into which a pilot drill of a hole saw can be inserted, so as to enlarge the hole in which the base body is inserted in terms of its diameter.

A similar device is described in U.S. Pat. No. 6,409,437 B1. DE 2 256 938 A describes a dowel for fastening in plaster walls, wherein the dowel has a thread on its outer shell wall and has a central opening into which a screw can be tightened. Known from DE 2 349 549 Al is a frustoconical housing insert with a male thread that can be connected with a cleaning device.

### SUMMARY OF THE INVENTION

The object of the invention is to improve the generic device in a manner beneficial for use.

The object is achieved by the invention indicated in the claims. The subclaims constitute not only advantageous further developments of the device indicated in the main claim, but also standalone solutions to the object.

Initially and essentially proposed is that the frustoconical base body have a cone shell surface that carries a thread. The thread is preferably formed by one or several righthand threaded ribs. As a consequence of the inventive configuration, the base body can initially be inserted into the hole to be enlarged in terms of its diameter, for example in a plasterboard wall, and then screwed in. For this purpose, it proves advantageous that the at least one threaded rib have a cross sectional contour that corresponds or at least equates to a self-tapping thread, so that a cutting edge formed by vertex lines can cut into the inner wall of the hole to be enlarged. The distance between two adjacent vertex lines is preferably greater than 1 mm, but should be smaller than 5 mm. The thread pitch can thus lie within a range of between 1 mm and 5 mm. The preferred distance between two vertex lines is 2 mm. The thread pitch can likewise preferably measure 2 mm. The two threaded flanks that meet in the vertex line run straight in the longitudinal cross section. They can assume an angle at the vertex that ranges between 60° and 100°, preferably measuring 90°. A further development of the invention provides that the insertion opening be formed by a bearing bush. The bearing bush can consist of metal. An intake cavity can be integrally formed by the base body. It can further be provided that the base body be a hollow body. It can have an opening that faces the base surface of the base body. This opening can be covered by a cover plate. One or several reinforcing ribs can be located in the opening, which connect an inner wall of the base body with an outer wall of a central sleeve section, into the sleeve section of which the bearing bush comprised of hardened metal, in particular hardened steel, is inserted. It is advantageous if the bearing bush can be replaced. A first bearing bush with a first diameter can be pulled out of the intake cavity in an axial direction, and replaced by a second bearing bush with a different diameter. Therefore, it is possible to use hole saws with pilot drills that differ from each other. Screw-in openings can be provided into which the screws used to fasten the cover plate to the base body can be screwed. The cover plate can have mounting holes for the screw to engage through. Two mounting holes can diametrically oppose each other relative to a center of the cover plate. The cover plate further has a central opening that aligns with the insertion opening. The pilot drill can be inserted through this central opening.

The invention further relates to a device of the kind described above with a male thread on the frustoconical shell surface. The device comprises a screwdriver that has a blade section and an activation section. The blade section can be inserted into at least one engaging slot of the device described above, for example of the base body, but preferably of the cover plate. Provided in particular are two engaging slots that lie diametrically opposite each other relative to a center of the cover plate, into which a respective end section of the blade section can be inserted. The screwdriver can be used to screw the base body into the hole to be enlarged, so as to exert a correspondingly large torque on the base body. The cover plate and the screwdriver can consist of metal, in particular steel.

The screwdriver can be a flat piece. Test openings can further be provided in the screwdriver. These can have a circular cross section with varying diameters.

### BRIEF DESCRIPTION OF THE DRAWINGS

The invention will be described below based upon attached drawings. Shown on:

FIG. 1 is a perspective view of a device according to the invention in the form of a drilling aid for enlarging holes,

FIG. 2 is an illustration according to FIG. 1, but with the tool 9 removed,

FIG. 3 is a top view of the device 1,

FIG. 4 is a section according to line IV-IV on FIG. 3,

FIG. 5 is an exploded view of the device 1,

FIG. 6 is an illustration to explain the use of the device 1 together with a workpiece 20, which has a hole 21, prior to inserting the device 1 into the hole 21 to be enlarged,

FIG. 7 is a follow up to FIG. 6, wherein the device 1 is placed in the hole 21 to be enlarged, wherein a screwdriver 9 is used to cut a male thread 15 of the device 1 into the wall of the hole 21,

FIG. 8 is the section according to line VIII-VIII on FIG. 7, with threads 15 cut into the wall of the hole 21,

FIG. 9 is a magnified follow-up to FIG. 8, wherein an insertion opening 5′ of the device 1 has inserted into it a pilot drill 19 of a hole saw 17, whose saw body 18 has a larger diameter than the largest diameter of the device 1,

FIG. 10 is a follow-up to FIG. 9, wherein a drilling machine that engages the shaft 19′ has imparted rotation to the saw body 18, and its saw teeth have fabricated a second hole 21′ with an enlarged diameter.

### DESCRIPTION OF THE EMBODIMENTS

The device shown in the drawings consists of a screw-in body and a screwdriver. The screwdriver has a frustoconical base body 1, which consists of a plastic part. The frustoconical base body 1 has a frustoconical shell surface 2, upon which one or several threaded ribs 15 are located. It is sufficient that one threaded rib 15 be located on the frustoconical shell surface 2, which helically extends from the base edge to the head edge of the base body. The threaded rib 15 can have the cross sectional profile of a self-tapping thread. The threaded rib 15 preferably has vertex lines 15′, which are each adjoined by two threaded flanks 15″. The threaded flanks 15″ converge in a linear valley. The selected thread pitch is such that the vertex lines 15′ can dig into the side walls of a hole 21 of a workpiece 20 to be enlarged. The screwdriver can be used to apply the torque required for this purpose, so as to screw the base body into the hole to be enlarged as kind of a screw. The threaded flanks 15″ converge in the vertex line 15′ at an angle that can measure about 90° or lie within a range of between 80° and 100°.

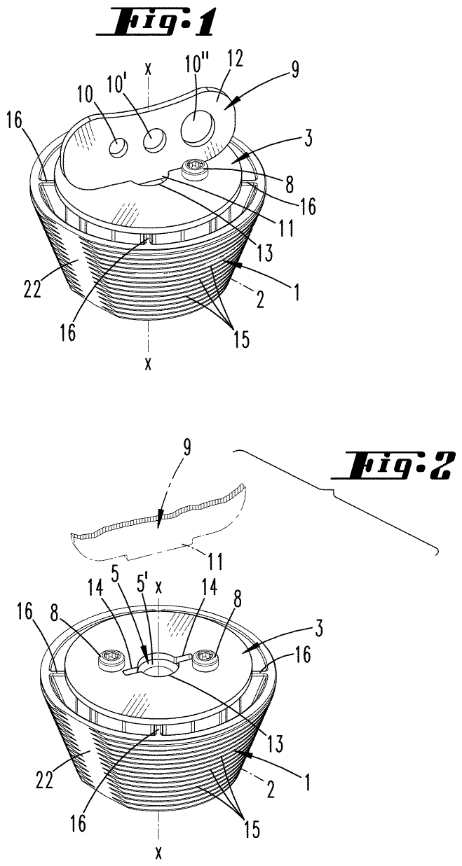

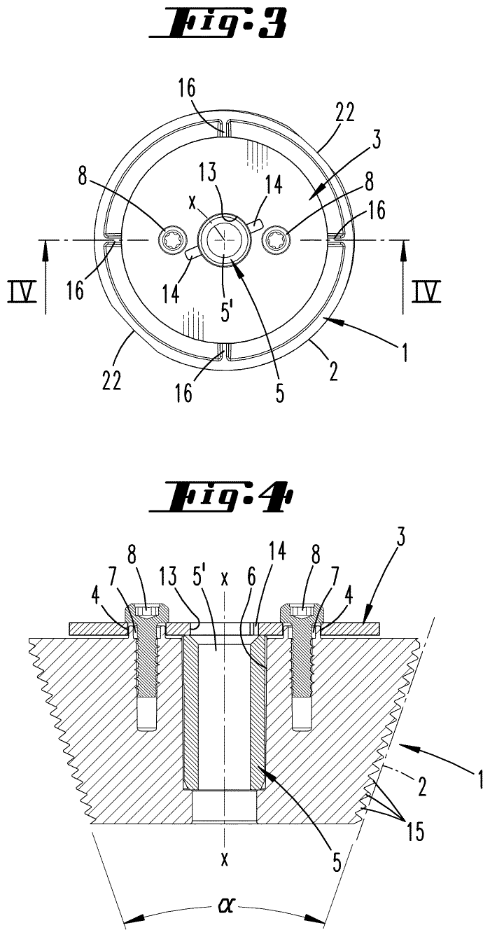

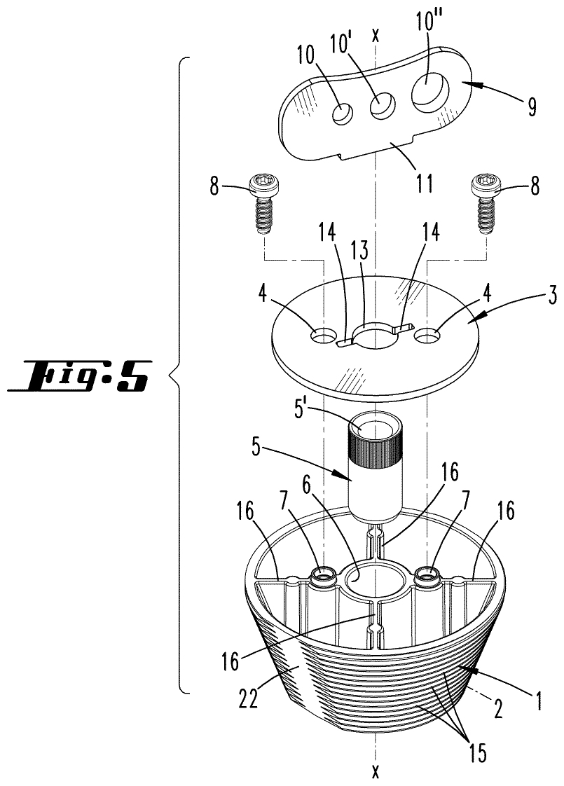

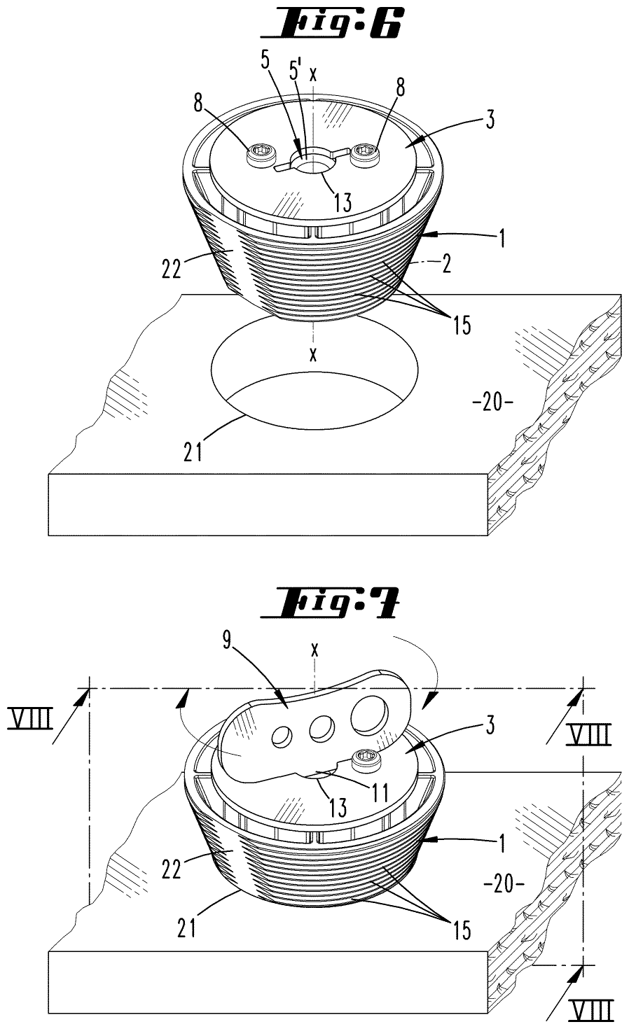

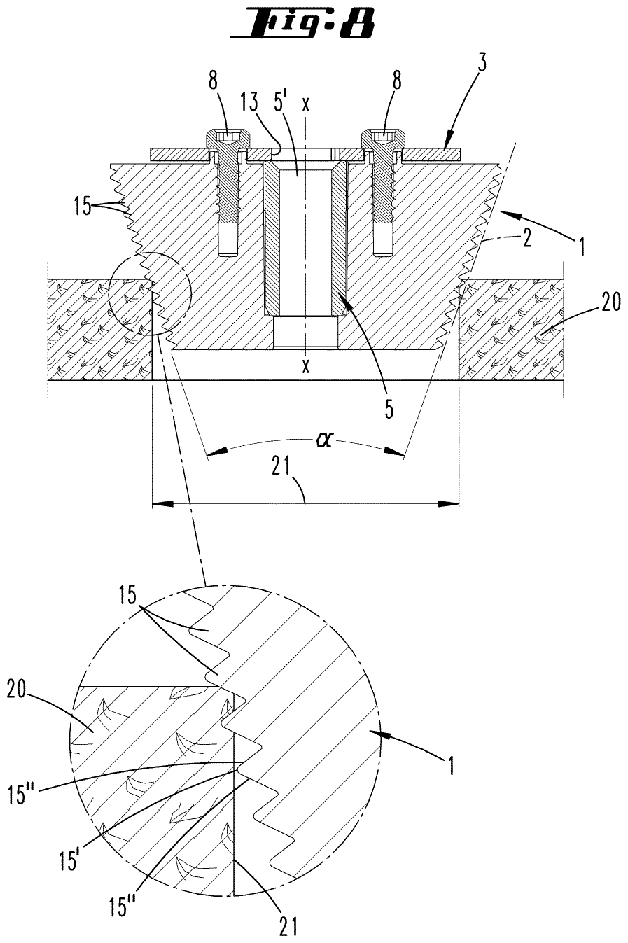

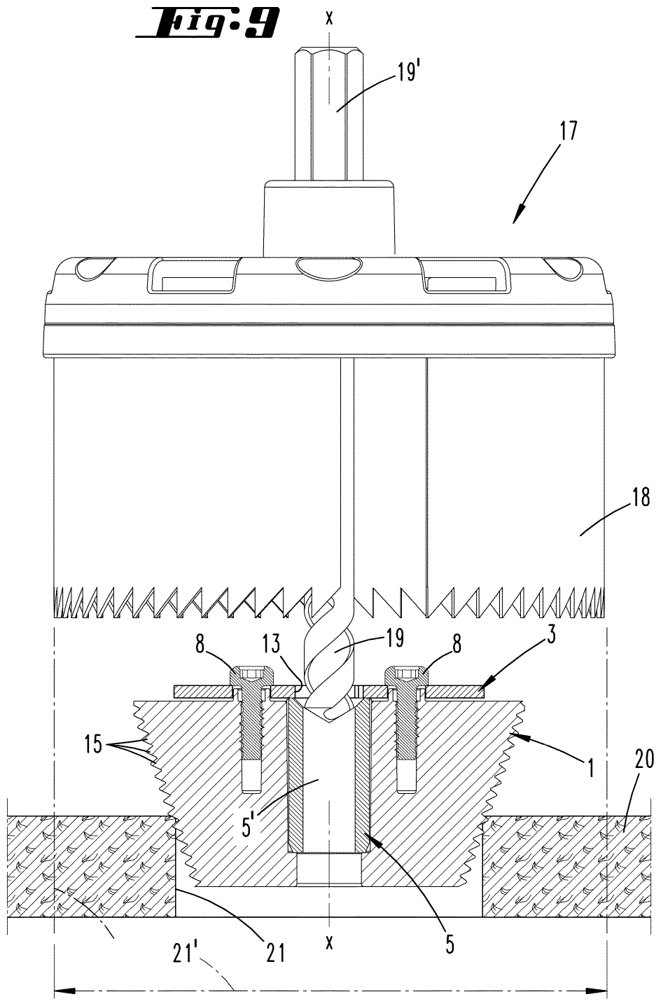

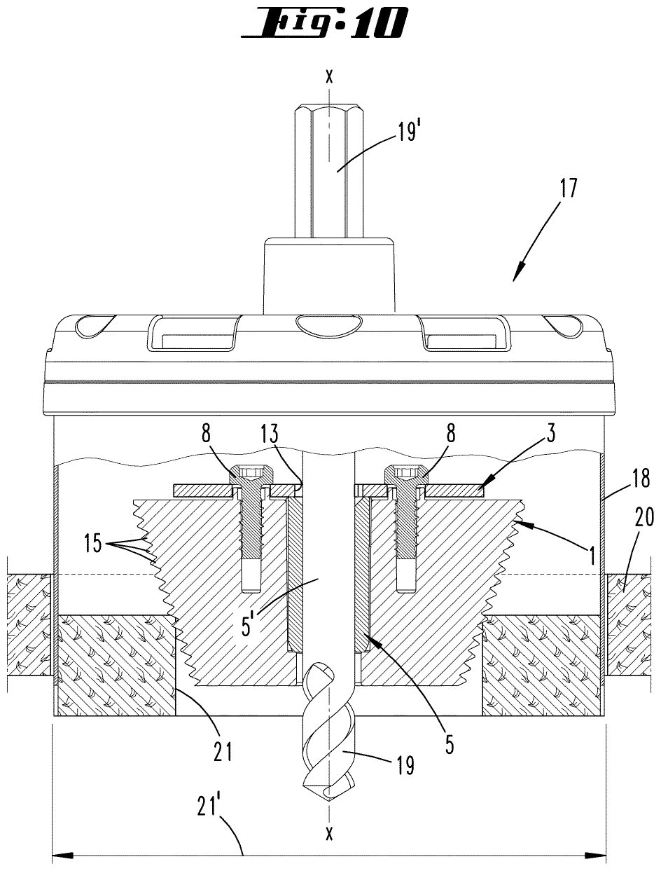

As shown on FIGS. 1 and 2, the threaded rib does not uninterruptedly surround the frustoconical base body 1. The male thread is rather interrupted in a circumferential section by a flattened area 22. The threads that end there form chip edges, in a sense, which dig into the wall of a hole 21 to be enlarged while screwing the male thread into the wall.

The base body 1 is a hollow body. It is open to its base side. The opening forms five partial openings. Four cavity sections that each adjoin the outer wall of the base body 1 lie next to each other in the circumferential direction, and are each separated from each other by reinforcing ribs 16. The reinforcing ribs 16 connect the outer wall of the base body 1 with an inner sleeve section. The sleeve section has a central opening that forms an intake cavity 6, into which a hardened drilling bush or bearing bush 5 extends. The bearing bush 5 has an insertion opening 5′, into which a pilot drill 19 of a hole saw 17 can be inserted.

The bearing bush 5 can be replaced by another bearing bush with a different diameter, so that a pilot drill with a different diameter can be used.

The open side of the base body 1 is covered with a cover plate 3. The cover plate 3 consists of steel, and has two mounting holes 4 lying diametrically opposite each other relative to a center. Mounting screws 8 that are screwed into screw-in openings 7 of the base body 1 engage through the mounting holes 4. The screw-in openings 7 are located in the area of a reinforcing rib 16.

The cover plate 4 has a central opening 13, the edge of which is interrupted by to engaging slots 14 lying diametrically opposite each other. The engaging slots 14 are open toward the edge, and align with each other.

Provided is a screwdriver 9, which consists of a sheet steel and comprises an activation section 12 and a blade section 11. The activation section 12 can be held by the fingers of the hand of a person. The blade section 11 can be inserted into the engaging slot 14. By exerting a torque on the screwdriver 9, the base body 1 placed in a hole 21 to be enlarged can be anchored in the hole 21 in such a way that the vertex lines 15′ dig into the wall of the hole 21.

The insertion opening 5′ is preferably located in the symmetry axis of the base body 1. A pilot drill 19 of a hole saw 17 can be inserted into the insertion opening 5′. The diameter of the saw body 18, whose lower edge has saw teeth, is larger than the outer diameter of the base body 1, so that the base body 1 can be completely overlaid by the bell-shaped saw body 18 of the hole saw 17. The hole saw 17 is used to drill a core out of the workpiece 20, which contains the hole 21 to be enlarged with the base body 1 inserted therein.

The screwdriver 9 can be used to unscrew the base body 1 back out of the hole 21. The gripping section of the screwdriver further has several diameter testing ports 10, 10′, 10″ for checking the diameter of drills.

The above statements serve to explain the inventions covered by the application as a whole, which each also independently advance the prior art at least by the following feature combinations, wherein two, several or all of these feature combinations can also be combined, specifically:

A device, characterized in that the frustoconical shell surface 2 of the base body 1 carries a thread.

A device, characterized in that the thread has at least one threaded rib 15, which has essentially flat threaded flanks 15″ that converge in a vertex line 15′, and/or that the thread is a self-tapping thread.

A device, characterized in that the distance between two adjacent vertex lines 15′ is larger than 1 mm, and in particular smaller than 5 mm, and/or that the thread pitch of the thread measures between 1 mm and 5 mm.

A device, characterized in that the insertion opening 5′ is comprised of a bearing bush 5, which in particular is arranged in an intake cavity 6 of the base body 1, and/or that the insertion opening 5′ runs in the geometric center of the base body 1.

A device, characterized in that the base body 1 consists of plastic or metal, for example steel, and/or is a hollow body, which is open in particular on its end face with the larger diameter.

A device, characterized in that the opening of the base body 1 designed as a hollow body is covered by a cover plate 3, which has a central opening 13 concentrically arranged to the insertion opening 5′, and/or consists of plastic or metal, for example steel.

A device, characterized by a screwdriver 9 with a blade section 11, wherein an insertion opening 14 is provided in the base body 1 or in the cover plate 3 for inserting the blade section, and/or that a central opening 13 in the cover plate 3 has two engaging slots 14 lying opposite each other.

A device, characterized by diameter testing ports 10, 10′, 10″ in a gripping area of the screwdriver 9.

A device, characterized in that a cone angle α of an enveloping cone lies within a range of between 30° and 50°, and/or that the diameter of the base surface corresponds to about 1.5 to 2 times the axial length of the base body.

All disclosed features (whether taken separately or in combination with each other) are essential to the invention. The disclosure of the application hereby also incorporates the disclosure content of the accompanying/attached priority documents (copy of the prior application) in its entirety, also for the purpose of including features of these documents in claims of the present application. Even without the features of a referenced claim, the subclaims characterize standalone inventive further developments of prior art with their features, in particular so as to submit partial applications based upon these claims. The invention indicated in each claim can additionally have one or several of the features indicated in the above description, in particular those provided with reference numbers and/or indicated on the reference list. The invention also relates to design forms in which individual features specified in the above description are not realized, in particular if they are recognizably superfluous with regard to the respective intended use, or can be replaced by other technically equivalent means.

### REFERENCE LIST

1 Frustoconical base body
2 Frustoconical shell surface
3 Cover plate
4 Mounting hole
5 Bearing bush
5′ Insertion opening
6 Intake cavity
7 Screw-in opening
8 Screw
9 Screwdriver
10 Diameter testing port
10′ Diameter testing port
10″ Diameter testing port
11 Blade section
12 Activation section
13 Central opening
14 Engaging slot
15 Threaded rib
15′ Vertex lines
15″ Threaded flank
16 Vertex lines
17 Hole saw
18 Saw body
19 Pilot drill
19′ Shaft
20 Workpiece
21 Hole
21′ Enlarged hole
22 Flattened area
α Cone angle

1-10. (canceled)

11. A device for enlarging a hole in a workpiece, comprising: a frustoconical base body that is insertable into the hole; and an insertion opening in the base body for insertion of a pilot drill of a hole saw, wherein the base body has a frustoconical shell surface that carries a thread.

12. The device according to claim 11, wherein the thread has at least one threaded rib, which has essentially flat threaded flanks that converge in a vertex line.

13. The device according to claim 11, wherein the thread is a self-tapping thread.

14. The device according to claim 12, wherein a distance between two adjacent vertex lines is larger than 1 mm.

15. The device according to claim 14, wherein the distance between two adjacent vertex lines smaller than 5 mm.

16. The device according to claim 12, wherein the thread has a thread pitch between 1 mm and 5 mm.

17. The device according to claim 11, wherein the insertion opening is comprised of a bearing bush and/or the insertion opening runs in a geometric center of the base body.

18. The device according to claim 17, wherein the bearing bush is arranged in an intake cavity of the base body.

19. The device according to claim 11, wherein the base body is plastic or metal.

20. The device according to claim 19, wherein the base body is steel.

21. The device according to claim 11, wherein the base body is a hollow body that is open on a end face with a larger diameter.

22. The device according to claim 21, further comprising a cover plate that covers the opening of the hollow base body, wherein the cover plate has a central opening concentrically arranged to the insertion opening.

23. The device according to claim 22, wherein the cover plate is plastic or metal.

24. The device according to claim 23, wherein the cover plate is steel.

25. The device according to claim 22, further comprising a screwdriver with a blade section, wherein an insertion opening is provided in the base body or in the cover plate for insertion of the blade section.

26. The device according to claim 25, wherein the central opening in the cover plate has two engaging slots lying opposite each other.

27. The device according to claim 25, wherein the screwdriver has a gripping area with diameter testing ports.

28. The device according to claim 11, wherein the frustoconical shell surface of the base body defines an enveloping cone having a cone angle (a) within a range of between 30° and 50°.

29. The device according to claim 11, wherein the base body surface has a diameter that corresponds to about 1.5 to 2 times and axial length of the base body.
